(19) United States
(12) Patent Application Publication
(10) Pub. No.: US 2026/0346144 A1
(43) Pub. Date: Nov. 5, 2026

(54) REDUCING THE LATENCY OF REMOTE GAMES AND REMOTE APPLICATIONS OF OTHER TYPES BY PREDELIVERING FUTURE OUTPUTS RESPONSIVE TO PREDICTED INPUTS

(71) Applicant: Playcast, Inc., Seattle, WA (US)

(72) Inventors: Aaron Lewis Overton, Blountville, TN (US); Alexander Kingsley St. John, Arlington, WA (US)

(21) Appl. No.: 19/327,601

(22) Filed: Sep. 12, 2025

Related U.S. Application Data
(60) Provisional application No. 63/800,113, filed on May 5, 2025.

(51) Int. Cl. A63F 13/67; A63F 13/52; A63F 13/79

(52) U.S. Cl. CPC A63F 13/67; A63F 13/52; A63F 13/79

(57) ABSTRACT

A facility for facilitating play of a game by a user of a user computing device is described. The game has a present state determined by a game engine executing on a remote computing device connected to the computing device by a network. The facility utilizes a memory storing a data structure containing multiple entries each representing a different next player action possible in view of the state of the game. Each entry contains an output sequence generated by the game engine to be responsive to performance of the next player action in the game's state. The contents of the data structure are usable to render the output sequence in response to performance of any of the plurality of next player actions, without further resort to the remote computing device.

### CROSS-REFERENCE TO RELATED APPLICATION(S)

This Application claims the benefit of U.S. Patent Application No. 63/800,113, filed May 5, 2025, and entitled “IMPROVING THE PERFORMANCE OF REMOTE GAMES AND REMOTE APPLICATIONS OF OTHER TYPES BY PREDELIVERING FUTURE OUTPUTS RESPONSIVE TO PREDICTED INPUTS,” which is hereby incorporated by reference in its entirety.

In cases where the present application conflicts with a document incorporated by reference, the present application controls.

### BACKGROUND

One view of computer games is participating in an artificial world. That world is rendered to a player's senses, via such outputs as video displayed to the player on a display device of a character running toward a barrel, and audio outputted by speakers to the player of sounds made by the barrel rolling toward the character. The world as rendered responds to inputs from the user. For example, if the user issues a jump command by pressing a particular button on a controller or a key on a keyboard, the world as rendered may adapt by launching the character into the air over the barrel in subsequent video frames, accompanied by a “boing” sound.

“Local” games execute on a computing device—such as a PC or gaming console in the player's home—to which are directly connected the input devices that receive the player's input, and output devices that the player sees and hears.

“Remote” games, on the other hand, execute at least in part on a computing device, such as a server, that is some distance from the input and output devices. For example, the input and output devices may be directly connected to a PC or gaming console in the player's home, which communicates inputs via a broadband network connection to a server 100 miles away. The game software executing on the server updates the state of the game's artificial world in response to the input, generates corresponding output, and sends the output back to the player device for rendering via the same network connection.

### BRIEF DESCRIPTION OF THE DRAWINGS

FIG. 1 is a data flow diagram showing sample data exchanges between a user device and a server for a conventional remote game or other remote application.

FIG. 2 is a block diagram showing some components typically incorporated in at least some of the computer systems and other devices on which the facility operates.

FIG. 3 is a data flow diagram showing data exchanged in the play of a remote game or execution of other remote application in accordance with the facility.

FIG. 4 is a flow diagram showing a process performed by the facility in some embodiments in the game server, such as by the facility's server-side agent.

FIG. 5 is a flow diagram showing a process performed by the facility to perform a user-side caching process in some embodiments.

FIG. 6 is a flow diagram showing a process performed by the facility in some embodiments to process an input generated by the player on the user device.

### DETAILED DESCRIPTION

The inventors have recognized that the reliance of conventionally-implemented remote games on network communication introduces latency between inputs and responsive outputs that can make the game seem less realistic and immersive, and therefore less enjoyable.

The inventors have also recognized that intensive and sustained efforts to reduce this latency via approaches such as faster networking hardware, drivers, and routing; more effective video and audio compression; more powerful server computing hardware; etc. consistently encounter limits that prevent them from overcoming the problem in a satisfying way.

The inventors have further recognized that categories of software other than games can benefit from being implemented in a remote manner, and are similarly negatively affected by the same latency effect. As one example, a CAD model may be so large and complex that it can only be effectively stored and revised on a powerful server with great storage capacity that is remote from the user device. If each small change to the model takes a second or more to be reflected in its rendering on a device local to the user, though, this interferes with the flow and efficacy of working on the model in this way.

In response, the inventors have conceived and reduced to practice a software and/or hardware facility for improving the performance of remote games and remote applications of other types by predelivering future outputs responsive to predicted inputs (“the facility”). In many situations, the facility delivers real-time interactivity over arbitrarily long distances with zero latency by predicting future inputs and pre-delivering responsive outputs before the user has taken an input action.

In some embodiments, the facility establishes a user-side agent on a computing device local to the player (or “user”), and a server-side agent on a server remote from the player that is executing at least a portion of a game, or subject remote software of another type. The server-side agent periodically predicts, based on the present state of the game, a set of alternative input actions the user is most likely to next take. For example, where the state of the game is that a character controlled by the player is running toward a barrel, the server-side agent may predict that the most likely alternative next input actions are (1) jumping up to pass above the barrel, (2) reversing direction to run away from the barrel, or (3) continuing to run toward the barrel to collide with it. For each of the predicted likely input actions, the server-side agent causes the game software to generate an output segment that is responsive to the predicted input, such as a 16-frame audio/video sequence produced by the game based on its present state and the predicted input. To extend the example, three audio/video sequences showing the character (1) jumping up to pass above the barrel, (2) reversing direction and running away from the barrel, or (3) continuing to run toward the barrel and colliding with it. The server-side agent sends these output segments to the user-side agent for caching on the user device, each with an indication of the input actions to which it is responsive.

When the user device receives input from the player, it forwards the input to the server as a basis for updating the game's state. At the same time, it is intercepted by the user-side agent, which determines whether the output cache contains an output segment indicated to be responsive to the input. In some cases, this involves determining whether the received input is within a range or set of different inputs specified for each cached output segment. If the user-side agent identifies an output segment that specifies the received input, it renders the output segment, such as by visually rendering a video component of the output segment on a user display device and rendering an audio component of the output segment on a user audio system. For example, where the received input corresponds to the jump action, the user device renders a cached output segment containing video and audio for jumping over the barrel. Because this processing is all performed locally on the user device without reliance on the server to take any action, it can be performed without incurring any latency corresponding to network communications or server queueing or processing, in an amount of elapsed time that is short enough to be difficult or impossible for the player to discern.

When the server receives the input from the user device, it updates the game state—such as by changing the condition of the character to being in the air above the barrel. It again predicts probable next input actions; generates output segments for each; and populates them to the cache on the user device.

By operating in some or all of the ways described above, the facility enables a user to play a network game (or use a network application of another type) in a way not negatively impacted by latency, even with a user device whose processing and storage capacity are modest, and with a network connection that relatively limited in terms of latency and/or data rate.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, less powerful versions of the following devices can be used, and/or a greater number of users can be effectively supported using existing devices: servers; networking links or networks; network switches, repeaters, or other hardware. Servers can be located at a greater geographic and/or network distance from players, allowing them to be shared over larger groups of players, larger ranges of time zones, etc., allowing them to consistently maintain higher utilization levels and provide greater value.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, the computations performed by the facility to predict likely input actions; interact with game software to generate output segments for caching; and trigger their rendering on the user device are far too involved, extensive, and time-sensitive to practically be performed in the human mind. Relying on a human mind to perform these actions would prevent the facility from improving the latency of a remote game to any meaningful degree.

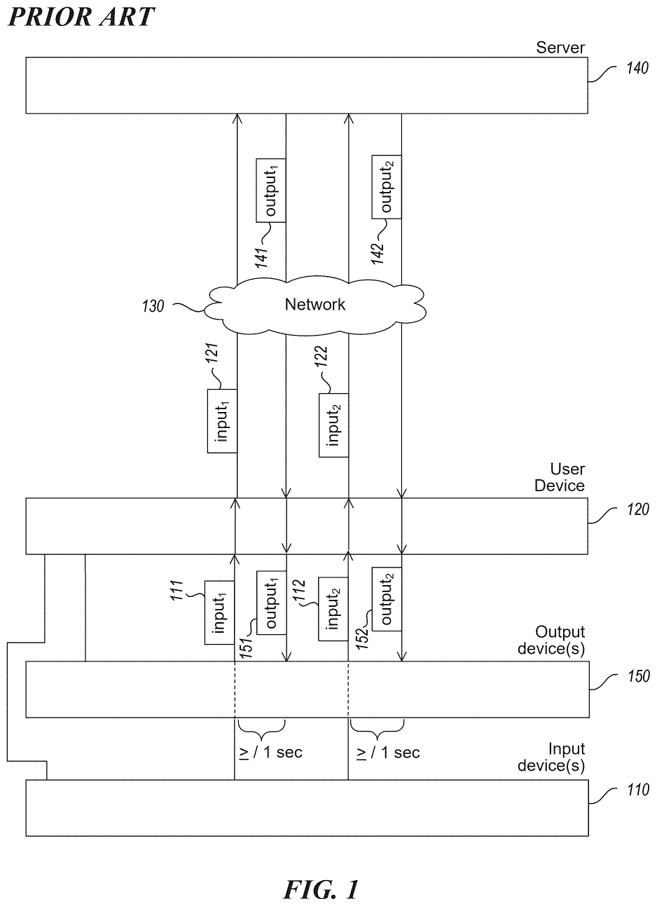

FIG. 1 is a data flow diagram showing sample data exchanges between a user device and a server for a conventional remote game or other remote application. One or more input devices 110 generate a first input to the game 111, and transmit them to a local user device 120, such as a gaming PC, gaming console, desktop computer, laptop computer, tablet computer, smartphone, or XR device. These input devices can be of a wide variety, including game pads, keyboards, mice, microphones, joysticks, flight sticks, light guns, steering wheels with or without pedals, dance pads, cameras, motion controllers, eye trackers, or brain-machine interfaces. The input data generated by the input devices may be of a wide variety of types, including binary values, quantitative values, directions, actions, commands, velocities, positions or directions in 2D or 3D space, speech, etc.

The user device forwards the first input 121 across a network connection 130 to a server 140 executing software constituting at least part of the game, such as a game engine. In some embodiments, this software executing on the server is responsible for determining, maintaining, and updating a state of the game. The state of the game can include information about, for example, the amount of time elapsed in the game; the number of characters operating in the game, and their mapping to particular players or artificial intelligence control; scorekeeping in the game; inventory management in the game; the position, movement, and interaction of characters in the game; aspects of the environment of the game, and players' interaction with them; etc. Upon receiving the first input, the software on the server updates the state of the game, and generates output reflecting the updated state of the game. For example, where the input is to cause a character controlled by the player to jump, the output might be one or more video frames depicting this jumping. The server returns this first output 141 to the user device, which causes this first output 151 to be rendered on one or more output devices 150. In various cases, this can include, for example, monitors, speakers, headphones, projectors, XR headsets, haptic feedback devices, olfactory stimulators, brain-machine interfaces, etc. This round-trip process is often repeated for a number of further inputs, such as second input 112. In each case, because the rendering of an output depends on completion of the depicted network round trip, it is common for this output rendering to occur one second or longer after the corresponding input was generated.

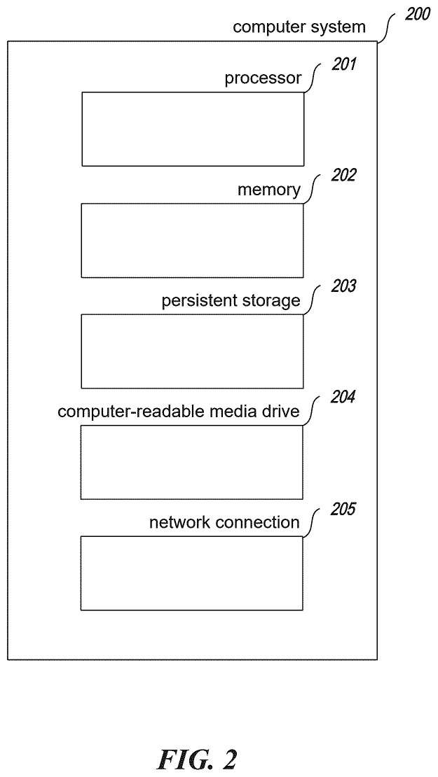

FIG. 2 is a block diagram showing some components typically incorporated in at least some of the computer systems and other devices on which the facility operates. In various embodiments, these computer systems and other devices 200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 2 and discussed above constitutes a data signal per se. While computer systems configured as described above are typically used to support the operation of the facility, those skilled in the art will appreciate that the facility may be implemented using devices of various types and configurations, and having various components.

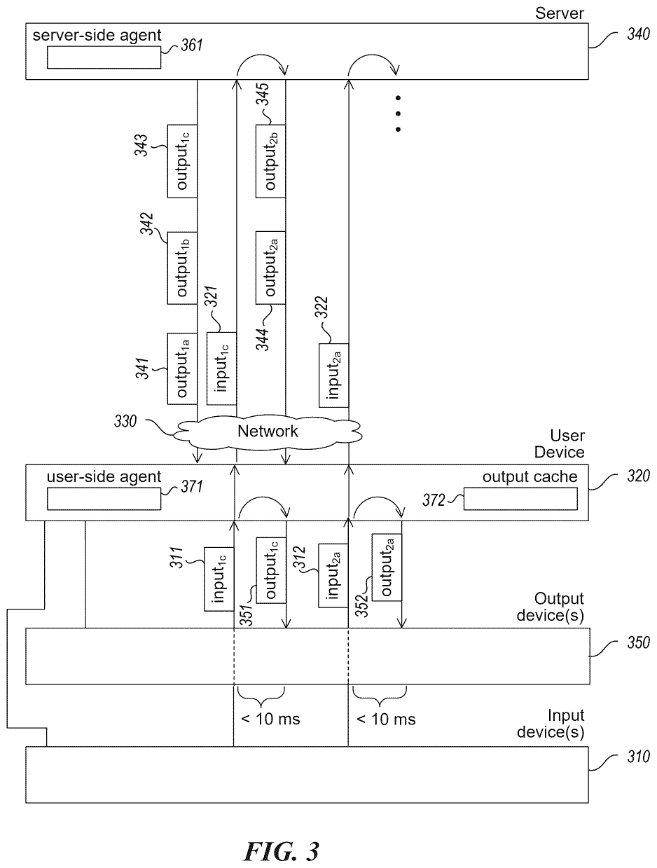

FIG. 3 is a data flow diagram showing data exchanged in the play of a remote game or execution of other remote application in accordance with the facility. At a certain point in the play of the game, a server-side agent 361 of the facility executing on the server 340—or an intermediary AI agent-makes a prediction about the most likely input actions that the player will next take, in a first round of player input. In general, the server-side agent makes these predictions based upon the present state of the game, as well as a variety of other considerations discussed in detail below. In the case of upcoming first round of user input, the server-side agent predicts three input actions that the player is likely to perform: input₁ₐ, input_{1b}, and input_{1c}. For example, input₁ₐ may be continuing to run toward a barrel, input_{1b} running away from a barrel, and input_{1c} jumping up and over the barrel. The server-side agent enlists the game software to generate, for each of these predicted inputs, an output segment in which the game responds to this predicted input. For example, these output sequences may be a first output sequence output₁ₐ 341 in which the user continues running toward the barrel and collides with it, and accompanying sounds; a second output segment output_{1b} 342 in which the user runs away from the barrel without colliding into it, and accompanying sounds; and a third output sequence output_{1c} 343 where the user leaps up and over the barrel, and accompanying sounds. The server-side agent causes these three output sequences 341-343 to be sent to the user device 320, at a point before any of these three predicted input actions has occurred. On the user device, a user-side agent 371 of the facility causes the three output sequences to be stored in an output sequence cache 372.

The user subsequently uses one or more input devices 310 to generate an input 311, in the first input round, which is received by the user device. In this case, the player's first-round input specifies input action input_{1c}, i.e., the jumping action. Upon receiving this input, the user-side agent acts in two ways: it forwards the first-round input 321 to the server, and it compares the input to input actions specified for output sequences stored in the output cache. In this comparison, the user-side agent matches the first-round input 311 to output_{1c} in the output cache, containing video frames and corresponding audio for the player's character jumping up and over the barrel. Without waiting for any response from the server, the user-side agent causes this matching output sequence 351 to be rendered on one or more output devices 350, such as playing the video frames on a visual output device and rendering the accompanying audio on a speaker or other output device. Because this process of rendering the first-round output in response to receiving the first-round input did not rely on sending or receiving any data over the network, it can be performed very quickly, such as in a period of time shorter than 10 milliseconds.

In some embodiments, rather than or in addition to relying on the server to generate predictive output segments for predicted input actions, the user side agent uses a video encoder of the user device to locally extrapolate future video frames corresponding to likely player inputs. In these embodiments, the vector flow field maintained for the output sequence by the video encoder for purposes of compression is used to predict the next video frame from one or more preceding video frames.

When the server receives the first-round input 321 sent by the user device, it passes this first-round input to the game software to update its state. The server-side agent then makes a new prediction of second-round inputs that are likely at this point in the game play, in light of the updated game state. In this case, it identifies two input actions that are likely in the second round of input, and causes the game software to generate output₂ₐ 344 for the first of these predicted input actions, and output_{2b} 345 for the second. It transmits these two second-round output sequences to the user device, where they are stored in the output cache by the user-side agent. As in the first round, one of these two new cached output sequences will be rendered 352 by the user device as soon as it receives an input 312 in the second round.

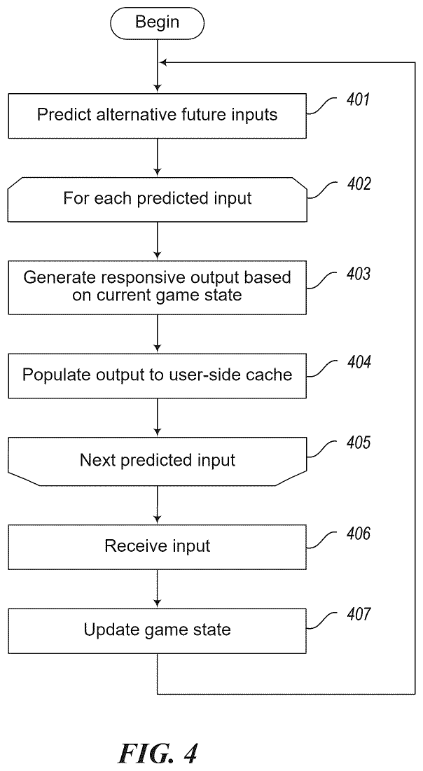

FIG. 4 is a flow diagram showing a process performed by the facility in some embodiments in the game server, such as by the facility's server-side agent. In some embodiments, the facility's server-side agent is integrated with the game engine, such as in the form of a plugin for a game platform in which the game is implemented, such as a Unity plugin, or an Unreal Engine plugin.

In act 401, the facility predicts the most likely alternative input actions to be generated by the player for the upcoming input round. In some embodiments, this prediction considers the state of the game, and the possible input actions it accommodates. In various embodiments, the facility uses a variety of approaches to predicting likely user actions, such as including using a machine learning model trained with user play sessions, or explicitly tracking the frequency of input actions in different game state scenarios. In some embodiments, the facility segments the player input data it considers in prediction based upon certain player attributes, such as play style, play proficiency, score, rank, game level or episode, gender, age, education level, time of day, day of week, geographic location, etc. In some embodiments, the facility defines dynamic “learning” player segments that the facility automatically moves individual players between based on how well the player's input actions are predicted based on the player input data received from members of the segment. In some embodiments, the facility considers in prediction only player input data from the same player, in some cases recognizing matches with prior patterns in this player's past inputs.

In some embodiments, the facility considers in its prediction of future input actions a typical minimum amount of time separating consecutive input actions by a single user, such as 70 milliseconds. In some such embodiments, the facility predicts that future input actions that fall within this expected latency window will be frenetic “random button mash” input actions, and generate more predictive output segments responsive to such input actions.

In acts 402-405, the facility loops through each possible alternative input action predicted in act 401. In act 403, the facility generates output responsive to the predicted input action based upon the current state of the game, such as by invoking the game software on the server.

In some embodiments, a game engine called by the facility in act 403 is not a traditional procedural game engine, but rather a game engine implemented in a generative machine learning model. In some such embodiments, the model-implemented game engine is trained to emulate a procedural game engine implementing the same game, such as in the manner described by Dani Valevski, Yaniv Leviathan, Moab Arar, and Shlomi Fruchter, Diffusion Models Are Real-Time Game Engines, available at arxiv.org/abs/2408.14837; and/or Dani Valevski, Yaniv Leviathan, Moab Arar, and Shlomi Fruchter, Diffusion Models Are Real-Time Game Engines, available at gamengen.github.io/, each of which is hereby incorporated by reference in its entirety. In some such embodiments, the generative machine learning model-based game engine implements a new game, details of which are specified by inputs including textual prompts describing the game, a player who will play it, sample imagery for the game, etc., such as is described by Noguer I Alonso, Miquel, The Mathematics of Genie 2: A Large-Scale Foundation World Model, Dec. 5, 2024, available at ssrn.com/abstract=5045438; Jack Parker-Holder, Philip Ball, Jake Bruce, Vibhavari Dasagi, Kristian Holsheimer, Christos Kaplanis, Alexandre Moufarek, Guy Scully, Jeremy Shar, Jimmy Shi, Stephen Spencer, Jessica Yung, Michael Dennis, Sultan Kenjeyev, Shangbang Long, Vlad Mnih, Harris Chan, Maxime Gazeau, Bonnie Li, Fabio Pardo, Luyu Wang, Lei Zhang, Frederic Besse, Tim Harley, Anna Mitenkova, Jane Wang, Jeff Clune, Demis Hassabis, Raia Hadsell, Adrian Bolton, Satinder Singh, and Tim Rocktäschel, Genie 2: A large-scale foundation world model, (Dec. 4, 2024), available at deepmind.google/discover/blog/genie-2-a-large-scale-foundation-world-model/; and/or Jake Bruce, Michael Dennis, Ashley Edwards, Jack Parker-Holder, Yuge (Jimmy) Shi, Edward Hughes, Matthew Lai, Aditi Mavalankar, Richie Steigerwald, Chris Apps, Yusuf Aytar, Sarah Bechtle, Feryal Behbahani, Stephanie Chan, Nicolas Heess, Lucy Gonzalez, Simon Osindero, Sherjil Ozair, Scott Reed, Jingwei Zhang, Konrad Zolna, Jeff Clune, Nando de Freitas, Satinder Singh, and Tim Rocktäschel, Genie: Generative Interactive Environments, Feb. 23, 2024, available at arxiv.org/html/2402. 15391v1, each of which is hereby incorporated by reference in its entirety.

In various embodiments, the generated responsive output is of various modes, such as video frames, video frames accompanied by audio, 3D video frames, 3D video frames accompanied by audio, etc. In some embodiments, the facility modulates various attributes of the predicted output it generates, such as dynamically. In various embodiments, the facility controls its caching of predictive output based upon a variety of factors. For example, in some embodiments, the facility varies the duration, quality level, or compression level of cached output sequences, or their number per prediction cycle, based upon factors such as a measured bandwidth, data transmission rate, network traffic level, round-trip latency time, server processing speed, or server load level; a level of importance or sensitivity attributed to latency at the present point in the game; a level of concentration demonstrated by the user in their explicit inputs to the game, or observed less directly via listening to the player or their auditory environment, observing the player via a camera, usage rates of the user device or other nearby devices for other purposes; etc. In some embodiments, the facility turns predictive caching on and off for a period of time using factors such as those discussed above. In some embodiments, where the capabilities of the user device are adequate, the facility generates some or all of the responsive output on the user device, such as by using artificial intelligence extrapolation.

In act 404, the facility populates the output generated in act 403 to the user-side cache, sending it to the user device via the network. In act 405, if additional predicted inputs remain to be processed, then the facility continues in act 402 to process the next predicted input, else the facility continues in act 406. In act 406, the facility receives an actual input generated by the player from the user device. In act 407, the facility causes the game to update its state in response to the received input. After 407, the facility continues in act 401 to predict a new set of future inputs based upon the game state as updated.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

In some embodiments, predicting each alternative future input in action involves specifying a range of actual inputs that correspond to—or qualify as—the input action. For example, for a sample “jump up” input action, the facility may define a range of actual input that includes pressing a “jump” gamepad button for a range of time durations; pushing upward on a joystick with a specified range of force levels; looking in an upward direction or moving the player's head in an upward direction within a specified range of degrees; speaking the word “jump” or “leap”, or a short phrase containing one of those words; etc.

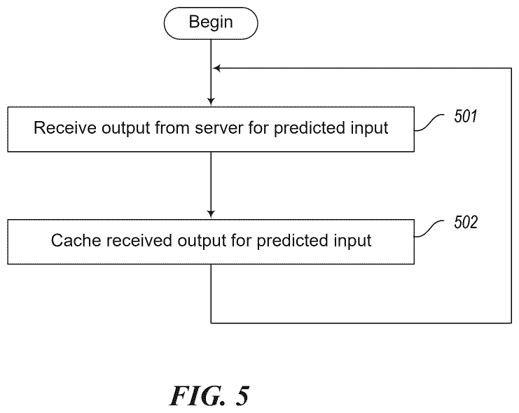

FIG. 5 is a flow diagram showing a process performed by the facility to perform a user-side caching process in some embodiments. In act 501, the facility receives an output from the server for a particular predicted input action. In some embodiments, the output is received together with a set of input ranges that will match this predicted input action. In act 502, the facility caches the information received in act 501 in an output sequence cache local to the user device. After act 502, the facility continues in act 501 to receive the next predicted output sequence.

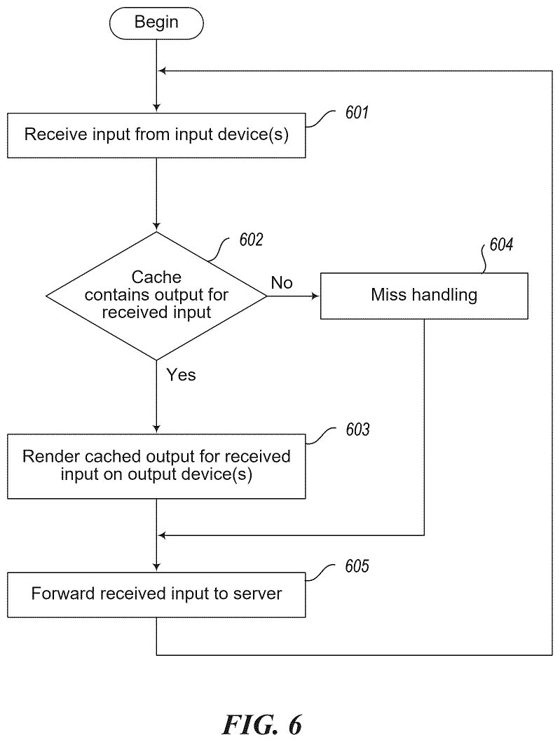

FIG. 6 is a flow diagram showing a process performed by the facility in some embodiments to process an input generated by the player on the user device. In act 601, the facility receives an input from one or more input devices connected to the user device. In various embodiments, the input received in act 601 is a single input event, or a sequence stream, set, or other combination of multiple input events. In various embodiments, these multiple input events can be in one or more modes, and can be generated with one or more individual input devices.

In act 602 if the cache contains a predicted output sequence that corresponds to the input received in act 601, then the facility continues in act 603, else the facility continues in act 604. In act 603, the facility renders the cached output for the received input on the appropriate output device or devices. In act 604, where the cache does not contain output responsive to the received input, then the facility performs cache miss handling. In various embodiments, this miss handling can involve rendering no output; rendering predetermined cache miss output, such as a brief humorous interlude video or animation clip; rendering dynamically-created output that is based on the output most recently rendered to the player; duplicating the previous frame; extrapolating a new frame from optical flow data; selecting the available frame that is closest to the target; using local artificial intelligence extrapolation; using motion blur or frame interpolation; etc. In some embodiments, the facility omits to perform any affirmative miss handling for cache misses, which may not be needed to provide an acceptable experience to the player in light of the brief period of time during which game play is impacted by a cache miss.

In act 605, the facility forwards the input received in act 601 to the server. In some cases, the facility annotates the forwarded input with information about which output segment is being rendered, including both cached output segments generated by the server and any miss handling output determined on the user device. After act 605, the facility continues in act 601 to receive the next input from the input devices.

In various embodiments, the facility performs various actions to maintain the contents of the output cache. In some embodiments, the facility empties the output cache at the end of each input cycle. In some embodiments, the facility maintains the contents of the output cache based upon directions sent by the server-side agent, including a direction to remove output sequences; a direction to maintain output sequences; a direction to retain particular output sequences for a particular length of time or number of input cycles; etc. In some embodiments, the facility manages the cache in a way that retains a large number of output sequences or individual frames, such as 100, 1000, 10,000, 100,000, 1,000,000, etc. In various embodiments, the facility prepopulates the cache before the player begins playing the first time with such a large number of output sequences or frames based upon input actions commonly performed by other users. In these embodiments, initial cache contents evolve over time to better match the individual player's playing style.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing device, comprising:
(a) accessing a current state of a player's play of a game;
(b) for the player, identifying a set of candidate next player actions each having relatively high probability among next player actions that are possible in the context of the accessed current game state;
(c) for each of the identified candidate next player actions, in response to receiving a previous player action advancing the state of the game to the current game state:
(1) invoking a game engine to generate a predictive output sequence that is responsive to the next player action being received from the player at a time when the game has the accessed current state;
(2) causing the generated predictive output sequence to be sent via a network to a user device for caching,
such that, when an input is received by the user device from the player that falls within a definition of one of the identified next player actions, the user device is capable of rendering the corresponding cached predictive output sequence irrespective of further communication with the computing device.

2. The method of claim 1 wherein the invoked game engine is implemented as a procedural program.

3. The method of claim 1 wherein the invoked game engine is implemented as a generative machine learning model.

4. The method of claim 1, further comprising:
receiving from the user device input received by the user device from the player;
in response to receiving the input:
invoking the game engine to update the current state of the game to reflect the received input; and
repeating acts (a), (b), (c), (c)(1), and (c)(2) based on the updated current state of the game.

5. The method of claim 1 wherein, a first one of the generated predictive output sequences is defined by specifying differences from a second one of the generated predictive output sequences.

6. The method of claim 1 wherein the rendering of each generated predictive output sequences occupies a time duration, the method further comprising:
determining a transit time amount of time it takes for network traffic to pass between the computing device and the client device; and
determining the time duration of the generated predictive output sequences based upon the determined transit time.

7. The method of claim 1 wherein each of the predictive output sequences is generated at a selected fidelity level, the method further comprising:
determining at least one attribute of network communication between the computing device and the client device; and
based at least on the determined at least one network communication attribute, determining the selected fidelity level.

8. The method of claim 1, further comprising:
for each of a plurality of players:
establishing a record of the player playing the game that reflects, at each of a plurality of times, each in a particular state of the game, a player action for which the player provided input;
using the established records to train a machine learning model to predict, for a player playing a game at a time when it has a particular state, the most likely next player actions, wherein the identifying comprises subjecting aspects of the accessed state of the game to the trained machine learning model.

9. The method of claim 8 wherein the trained machine learning model has at least one independent variable corresponding one or more player attributes.

10. The method of claim 8 wherein the training trains a plurality of machine learning models, each of the plurality of machine learning models being trained with the records established for players having a different value of a particular player attribute, the method further comprising:
selecting one of the plurality of machine learning models to which to subject the accessed state of the game based on a value of the particular player attribute for the player.

11. The method of claim 10, further comprising:
for each of a plurality of player attributes:
for each of a plurality of values of the player attribute:
training a machine learning model with the records established for players having the value of the player attribute,
comparing next player actions predicted by the trained machine learning for players having the value of the player attribute to actual next player actions performed by those players to determine an efficacy score for the model; and
selecting as the particular player attribute the player attribute among the plurality of player attributes having the highest determined efficacy scores.

12. The method of claim 1, further comprising:
for each of one or more players:
establishing a record of the player playing the game that reflects, at each of a plurality of times, each in a particular state of the game, a player action for which the player provided input;
compiling from the established records statistical frequencies at which each player action is performed in each game state,
wherein the identifying comprises selecting player actions having the highest statistical frequencies for the accessed state of the game.

13. The method of claim 12, further comprising:
selecting the one or more players based upon a player attribute that is common to the one or more players.

14. The method of claim 1, further comprising:
for each of the identified next player actions:
determining a range of inputs that qualify as the next player action; and
causing the determined range of inputs to be sent with the predictive output sequence that is responsive to the next player action to the user device for caching,
such that the determined ranges of inputs are usable to for any of the predictive output sequences, whether an input received by the user device falls within the definition of one of the identified next player actions.

15. One or more memories collectively having contents configured to cause a computing device to perform a method, the method comprising:
accessing a current state of an application;
for a user of the application, identifying a set of next user actions each having relatively high probability among user actions that are possible in the context of the accessed application state;
for each of the identified next user actions:
invoking code of the application to generate a predictive output sequence that is responsive to the next user action being received from the user at a time when the application has the accessed state;
causing the generated predictive output sequence to be sent via a network to a user device for caching,
such that, when an input is received by the user device from the user that falls within a definition of one of the identified next user actions, the user device is capable of rendering the corresponding cached predictive output sequence irrespective of further communication with the computing device.

16. The one or more memories of claim 15, the method further comprising:
receiving from the user device input received by the user device from the player; and
in response to receiving the input, invoking code of the application to update the state of the application to reflect the received input.

17. One or more memories directly connected to a user computing device, the one or more memories collectively containing a data structure, the data structure comprising, for a game being played by a user of the user computing device, the game having a present state determined by a game engine executing on a remote computing device connected to the computing device by a network:
a plurality of entries each representing a different one of a plurality of candidate next player actions possible in view of the present state of the game, each comprising:
an output sequence generated by the game engine to be responsive to performance of the next player action in the game's present state, the generation occurring in response to receiving a previous player action advancing the state of the game to the present state of the game,
such that the contents of the data structure are usable to render the output sequence in response to performance of any of the plurality of next player actions, without further resort to the remote computing device.

18. The one or more memories of claim 17 wherein each of the plurality of entries further comprises:
a range of inputs that qualify as the next player action represented by the entry.

19. The one or more memories of claim 17 wherein the output sequence contained by a first entry comprises is defined with reference to an output sequence contained by a second entry.

20. The one or more memories of claim 17 wherein the output sequences contained by the plurality of entries each comprise:
a series of two-dimensional video frames,
a series of three-dimensional video frames,
a series of binocular video frames,
an audio sequence, and/or
haptic feedback output.

21. A method in a computing device, comprising:
receiving via a network from a server computing system executing an application that determined a present state of an instance of the application being used by a user using the computing device a plurality of predictive output sequences, each predictive output sequence corresponding to a user action possible in the present state of the application instance and having been generated by the application assuming that the user action would be performed while the application instance has the present state, the predictive output sequences having been generated by the server computer system in response to receiving a previous user action advancing the state of the application instance to the present state of the application instance;
storing the received plurality of predictive output sequences each together with an indication of the user action to which it corresponds;
receiving input data from an input device local to the computing device;
identifying one of the user actions to which it corresponds; and
causing the predictive output sequence corresponding to the identified user action to be rendered on an output device local to the computing device.

22. The method of claim 21, further comprising:
transmitting the received input data to the server computing system via the network as a basis for the game engine to update the state of the game to reflect the received input data.

23. (canceled)

24. (canceled)
